(19) United States
(12) Patent Application Publication
(10) Pub. No.: US 2012/0050332 A1
(43) Pub. Date: Mar. 1, 2012

(54) METHODS AND APPARATUSES FOR FACILITATING CONTENT NAVIGATION

(75) Inventors: Jari Nikara, Lempaala (FI); Mika Pesonen, Tampere (FI); Eero Aho, Tampere (FI); Tomi Aarnio, Tampere (FI)

(73) Assignee: Nokia Corporation

(21) Appl. No.: 12/868,235

(22) Filed: Aug. 25, 2010

(51) Int. Cl. G09G 5/00

(52) U.S. Cl. 345/660

(57) ABSTRACT

Methods and apparatuses are provided for facilitating content navigation. A method may include pre-rendering content at each of a plurality of zoom levels. The plurality of zoom levels may include a first zoom level and a second zoom level. The method may further include causing display of the pre-rendered content at the first zoom level. The method may additionally include determining a predefined user input defining an interaction with the content displayed at the first zoom level. The method may also include, in response to the determined input, causing display of the pre-rendered content at the second zoom level. Corresponding apparatuses are also provided.

### TECHNOLOGICAL FIELD

Example embodiments of the present invention relate generally to user interface technology and, more particularly, relate to methods and apparatuses for facilitating content navigation.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

The expansion of networking technologies and development of mobile computing devices has yielded mobile computing devices that may be used to access web pages and other content over networks using mobile web browsers. In this regard, some modern mobile computing devices may now be used to access network content services that were previously only available on desktop computers, thus providing a new level of mobility and convenience for users. However, mobile computing devices are still faced with limitations, such as more limited computing power and smaller device size. These limitations may negatively impact user experience when viewing content on a mobile device.

### BRIEF SUMMARY

Methods, apparatuses, and computer program products are herein provided for facilitating content navigation. Systems, methods, apparatuses, and computer program products in accordance with various embodiments may provide several advantages to computing devices, content providers, and computing device users. Some example embodiments facilitate content navigation by pre-rendering content at each of a plurality of zoom levels. Such example embodiments may facilitate a quick transition between content zoom levels when a user seeks to zoom in or out on content when viewing the content. In this regard, by pre-rendering the content at multiple zoom levels, the content may be quickly (e.g., instantaneously) displayed at a second zoom level when a user interacting with the content at a first zoom level provides a predefined input triggering adjustment of content zoom level. More particularly, the pre-rendered content may be displayed at the second zoom level responsive to the request rather than requiring the content to be rendered on the fly at the second zoom level subsequent to the request before displaying the content at the second zoom level. Accordingly, some example embodiments may provide a virtually instantaneous transition between zoom levels.

Such embodiments may be particular advantageous for users browsing content on a mobile device having a relatively small display. In this regard, the entirety of content, such as a web page, may not be concurrently viewable on a display at a zoom level sufficient to enable a user to read or otherwise interact with the content. Accordingly, when viewing the content at a zoom level sufficient to enable the user to read the content, only a portion of the content may be viewable on the display. If a user wishes to view another portion of the content, the user may need to scroll or otherwise pan the content until the desired portion is viewable in the display. If this panning is performed at a zoom level sufficient to enable reading the content, panning to a second portion of the content may be relatively time consuming and the user may not be able to easily locate a desired portion of the content. However, some example embodiments may advantageously enable a user to seamlessly transition to a zoomed out version of the content to enable navigation to a second portion of the content and then transition back to the pre-rendered zoomed in version focused on the second content portion. Accordingly, a user may be able to quickly and intuitively navigate web pages and other content using some example embodiments.

In a first example embodiment, a method is provided, which comprises pre-rendering content at each of a plurality of zoom levels. The plurality of zoom levels of this example embodiment comprises a first zoom level and a second zoom level. The method of this example embodiment further comprises causing display of the pre-rendered content at the first zoom level. The method of this example embodiment additionally comprises determining a first predefined user input defining an interaction with the content displayed at the first zoom level. The method of this example embodiment also comprises, in response to the determined first input, causing display of the pre-rendered content at the second zoom level.

In another example embodiment, an apparatus comprising at least one processor and at least one memory storing computer program code is provided. The at least one memory and stored computer program code are configured, with the at least one processor, to cause the apparatus of this example embodiment to at least pre-render content at each of a plurality of zoom levels. The plurality of zoom levels of this example embodiment comprises a first zoom level and a second zoom level. The at least one memory and stored computer program code are configured, with the at least one processor, to further cause the apparatus of this example embodiment to cause display of the pre-rendered content at the first zoom level. The at least one memory and stored computer program code are configured, with the at least one processor, to additionally cause the apparatus of this example embodiment to determine a first predefined user input defining an interaction with the content displayed at the first zoom level. The at least one memory and stored computer program code are configured, with the at least one processor, to also cause the apparatus of this example embodiment, in response to the determined first input, to cause display of the pre-rendered content at the second zoom level.

In another example embodiment, a computer program product is provided. The computer program product of this example embodiment includes at least one computer-readable storage medium having computer-readable program instructions stored therein. The program instructions of this example embodiment comprise program instructions configured to pre-render content at each of a plurality of zoom levels. The plurality of zoom levels of this example embodiment comprises a first zoom level and a second zoom level. The program instructions of this example embodiment further comprise program instructions configured to cause display of the pre-rendered content at the first zoom level. The program instructions of this example embodiment additionally comprise program instructions configured to determine a first predefined user input defining an interaction with the content displayed at the first zoom level. The program instructions of this example embodiment also comprise program instructions configured, in response to the determined first input, to cause display of the pre-rendered content at the second zoom level.

In another example embodiment, an apparatus is provided that comprises means for pre-rendering content at each of a plurality of zoom levels. The plurality of zoom levels of this example embodiment comprises a first zoom level and a second zoom level. The apparatus of this example embodiment further comprises means for causing display of the pre-rendered content at the first zoom level. The apparatus of this example embodiment additionally comprises means for determining a first predefined user input defining an interaction with the content displayed at the first zoom level. The apparatus of this example embodiment also comprises means for, in response to the determined first input, causing display of the pre-rendered content at the second zoom level.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described example embodiments of the invention in general terms, reference will now be made to the accompanying drawings, which are not necessarily drawn to scale, and wherein:

FIG. 1 illustrates a block diagram of a terminal apparatus for facilitating content navigation according to an example embodiment;

FIG. 2 is a schematic block diagram of a mobile terminal according to an example embodiment;

FIG. 3 illustrates a system for facilitating content navigation according to an example embodiment;

FIGS. 4a-c illustrate a series of content renderings according to an example embodiment;

FIG. 5 illustrates an example of content zooming according to an example embodiment; and

FIG. 6 illustrates a flowchart according to an example method for facilitating content navigation according to an example embodiment.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

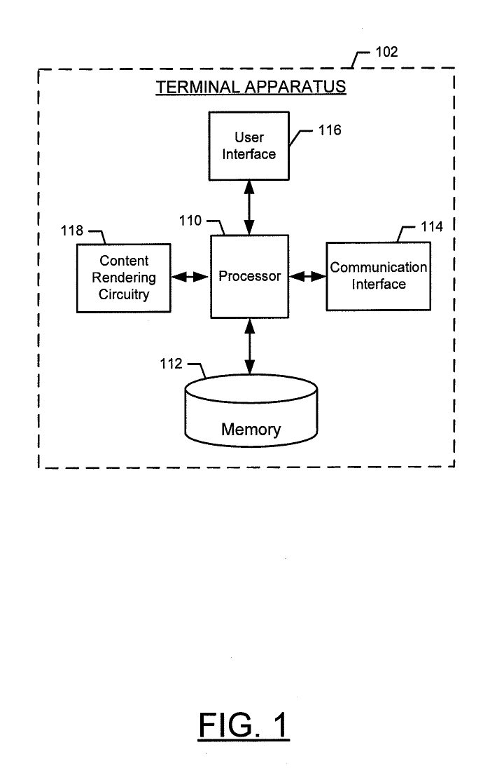

FIG. 1 illustrates a block diagram of a terminal apparatus 102 for facilitating content navigation according to an example embodiment. It will be appreciated that the terminal apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating content navigation, other configurations may also be used to implement embodiments of the present invention.

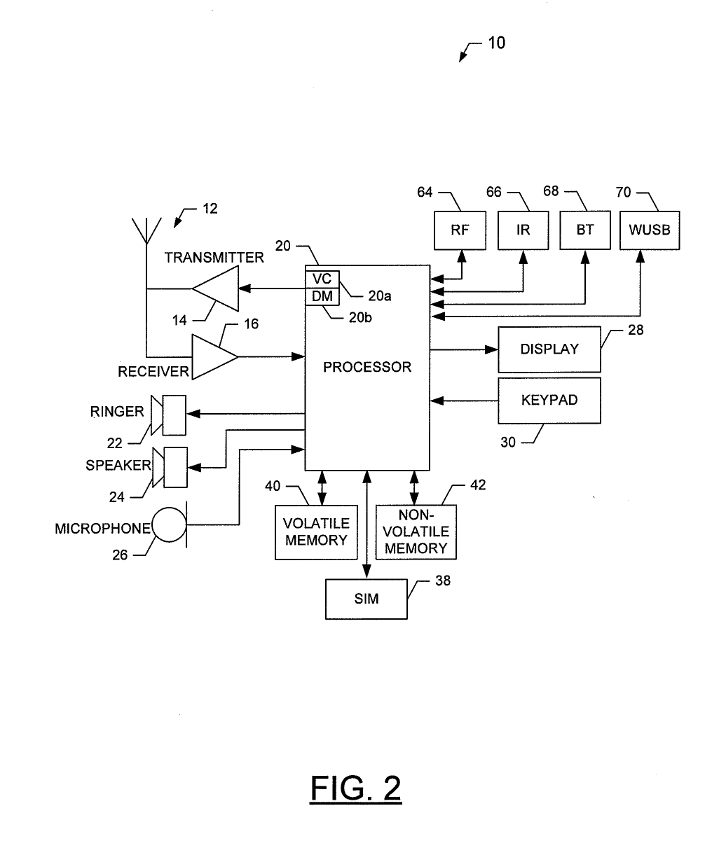

The terminal apparatus 102 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, any combination thereof, and/or the like. In this regard, the terminal apparatus 102 may comprise any computing device or other apparatus that comprises a display and/or is in operative communication with a display configured to display content rendered by the terminal apparatus 102. In an example embodiment, the terminal apparatus 102 is embodied as a mobile terminal, such as that illustrated in FIG. 2.

In this regard, FIG. 2 illustrates a block diagram of a mobile terminal 10 representative of one example embodiment of a terminal apparatus 102. It should be understood, however, that the mobile terminal 10 illustrated and hereinafter described is merely illustrative of one type of terminal apparatus 102 that may implement and/or benefit from various embodiments of the invention and, therefore, should not be taken to limit the scope of the present invention. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the terminal apparatus 102 includes various means for performing the various functions herein described. These means may comprise one or more of a processor 110, memory 112, communication interface 114, user interface 116, or content rendering circuitry 118. The means of the terminal apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the terminal apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, and/or content rendering circuitry 118 may be embodied as a chip or chip set. The terminal apparatus 102 may therefore, in some cases, be configured to or comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some example embodiments the processor 110 comprises a plurality of processors. The plurality of processors may be in operative communication with each other and may be collectively configured to perform one or more functionalities of the terminal apparatus 102 as described herein. The plurality of processors may be embodied on a single computing device or distributed across a plurality of computing devices collectively configured to function as the terminal apparatus 102. In embodiments wherein the terminal apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the terminal apparatus 102 to perform one or more of the functionalities of the terminal apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the terminal apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal apparatus 102 is embodied as a mobile terminal 10, the memory 112 may comprise the volatile memory 40 and/or the non-volatile memory 42. The memory 112 may be configured to store information, data, applications, instructions, or the like for enabling the terminal apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the content rendering circuitry 118 during the course of performing its functionalities.

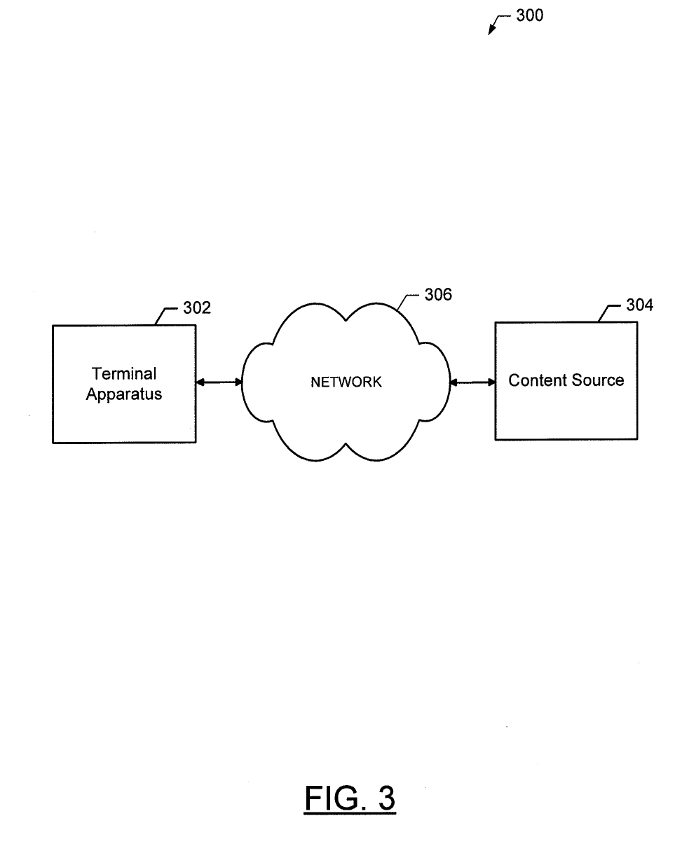

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the terminal apparatus 102 and one or more computing devices may be in communication. As an example, the communication interface 114 may be configured to receive and/or otherwise access web page content and/or other content over a network (e.g., the network 306 illustrated in FIG. 3) from a server or other content source (e.g., the content source 304). The communication interface 114 may additionally be in communication with the memory 112, user interface 116, and/or content rendering circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or content rendering circuitry 118, such as via a bus.

The content rendering circuitry 118 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In embodiments wherein the content rendering circuitry 118 is embodied separately from the processor 110, the content rendering circuitry 118 may be in communication with the processor 110. The content rendering circuitry 118 may further be in communication with one or more of the memory 112, communication interface 114, or user interface 116, such as via a bus.

FIG. 3 illustrates a system 300 for facilitating content navigation according to an example embodiment of the invention. The system 300 comprises a terminal apparatus 302 and a content source 304 configured to communicate over the network 306. The terminal apparatus 302 may, for example, comprise an embodiment of the terminal apparatus 102 wherein the terminal apparatus 102 is configured to communicate with a remote content source 304 over a network 306 to access content that may be rendered and displayed at the terminal apparatus. The content source 304 may comprise any computing device configured to provide content to the terminal apparatus 302 over the network 306. In this regard, the content source 304 may comprise, for example, a network attached storage device, a server, a desktop computer, laptop computer, mobile terminal, mobile computer, mobile phone, mobile communication device, audio/video player, any combination thereof, and/or the like that is configured to provide and/or otherwise share content with the terminal apparatus 302. The network 306 may comprise a wireline network, wireless network (e.g., a cellular network, wireless local area network, wireless wide area network, some combination thereof, or the like), or a combination thereof, and in one embodiment comprises the internet.

Accordingly, it will be appreciated that content described to be rendered and displayed in accordance with various embodiments disclosed herein may comprise content received or otherwise obtained by the terminal apparatus 102 from a content source 304 over a network 306. Additionally or alternatively, the content may comprise content that is locally stored at the terminal apparatus 302, such as in the memory 112. The content may comprise any content that may be rendered and displayed. In this regard, the content may comprise a web page, web content, text content, graphic content, some combination thereof, or the like. In embodiments wherein the content comprises a web page or other web content and the content is described to be displayed, the content may be displayed within a web browser.

In some example embodiments, the content rendering circuitry 118 is configured to pre-render content to be displayed at each of a plurality of zoom levels. The number of zoom levels at which the content is pre-rendered may vary depending on the particular embodiment. In this regard, in various embodiments, the content rendering circuitry 118 may determine the number of zoom levels at which the content is pre-rendered based at least in part on predefined settings, a predefined user preference, the type of content that is pre-rendered, any application specific requirements of an application with which an embodiment is used, and/or other the like.

Further, the actual zoom levels used to pre-render the content may similarly vary depending on the particular embodiment. Accordingly, the content rendering circuitry 118 may be configured to determine the zoom levels used to pre-render the content based at least in part on predefined settings, a predefined user preference, the type of content that is pre-rendered, any application specific requirements of an application with which an embodiment is used, and/or other the like. However, in some example embodiments, the zoom levels may be selected such that there is at least one zoom level (e.g., a higher zoom level) that enables a user to view and interact with content in detail (e.g., to read all of the text or see all of the features of the content) and at least one zoom level (e.g., a lower zoom level) that enables a user to view a high level view of the content. In this regard, the high level view of the content may facilitate navigating to and selecting a portion of the content to view in further detail (e.g., at the higher zoom level). This variation in zoom levels may be particularly advantageous when the content is displayed on a smaller display, such as may be found on a mobile terminal wherein the entirety of the content may not be concurrently visible when displayed on the mobile terminal display at a zoom level sufficient to enable a user to view and interact with the content in detail.

The content rendering circuitry 118 may be further configured to cause display of the pre-rendered content at one of the pre-rendered zoom levels. In this regard, the content rendering circuitry 118 may be configured to cause display of the content on a display that is embodied on or otherwise operatively connected to the terminal apparatus 102. The one of the pre-rendered zoom levels at which the content is displayed may, for example, be a default zoom level. It will be appreciated that where the content rendering circuitry 118 is described to cause display of pre-rendered content at a particular zoom level, the entirety of the content may not be concurrently visible on a display on which it is displayed. In this regard, the content may be larger than the display area of the display at a displayed zoom level such that only a portion of the displayed content is visible on the screen.

The pre-rendered content at the zoom level(s) that are not displayed may be in the background. For example, in some example embodiments, the content may be pre-rendered as a plurality of layers, with each layer having content pre-rendered at one of the pre-rendered zoom levels. Accordingly, one layer may be displayed such that it is viewable. The other layer(s) may be maintained in a memory for display when needed and/or may be layered underneath the displayed layer such that they are not viewable on the display due to being covered by the displayed layer. Thus, for example, where the content comprises a web page, the entire web page may be pre-rendered as a plurality of layers, with each layer comprising a pre-rendered version of the web page in its entirety at a different zoom level.

In some example embodiments, the content rendering circuitry 118 may not cause display of the pre-rendered content until the content rendering circuitry 118 has completed pre-rendering the content at each of the plurality of zoom levels. However, in other embodiments, the content rendering circuitry 118 may cause display of the content at a first zoom level prior to completion of the pre-rendering, so as to reduce delay between a user request for the content and display of the content to the user. In such embodiments, the content rendering circuitry 118 may cause display of the content at a first zoom level as the content is pre-rendered at the first zoom level or may wait for completion of rendering the content at the first zoom level prior to displaying the content. Regardless of the timing of display of the content, it will be appreciated that pre-rendering the content at the plurality of zoom levels may be performed before a request to view the content at a second zoom level such that the pre-rendered content is available at the second zoom level for display responsive to the request rather than first requiring rendering of the content at the second zoom level subsequent to the request.

The content rendering circuitry 118 may be further configured to determine a predefined user input defining an interaction with the content when displayed at a first zoom level. This user input may be any input predefined to trigger a switch to a different zoom level. The input may also vary depending on the means available for input on the user interface 116. For example, if the content is displayed on a touch screen display, the predefined input may comprise a predefined touch gesture to the touch screen display. As further examples, the predefined input may comprise a predefined button, key, soft key, mouse click, selection of a user interface menu item, or the like.

Responsive to detection of the predefined user input, the content rendering circuitry 118 may be configured to cause display of the content at a pre-rendered second zoom level. In this regard, the content rendering circuitry 118 may cause display of the content at a second zoom level having been pre-rendered in advance of determining the predefined user input. In embodiments wherein the content is pre-rendered as a plurality of layers, the content rendering circuitry may cause display of the content at a pre-rendered second zoom level by swapping a layer pre-rendered at the first zoom level with a layer pre-rendered at the second level. Accordingly, the content may be displayed at the second zoom level more rapidly from the user perspective rather than if the user had to wait for the content to be re-rendered at the second zoom level prior to display of the content at the second zoom level.

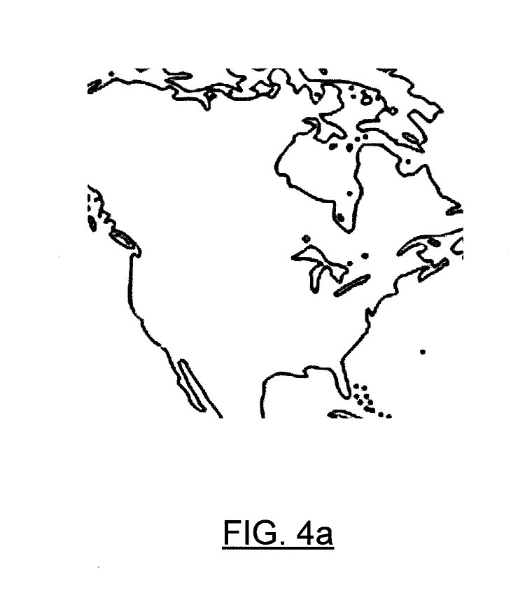

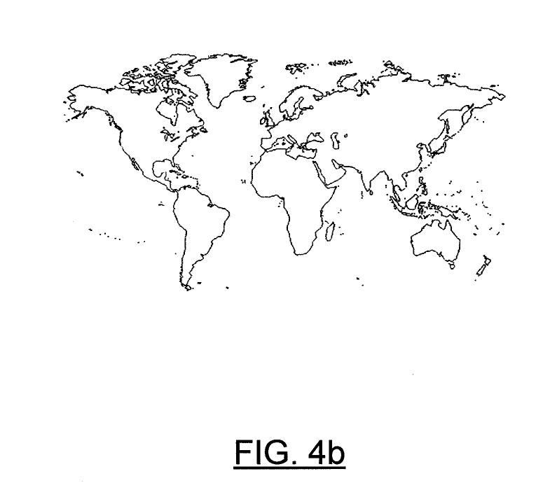

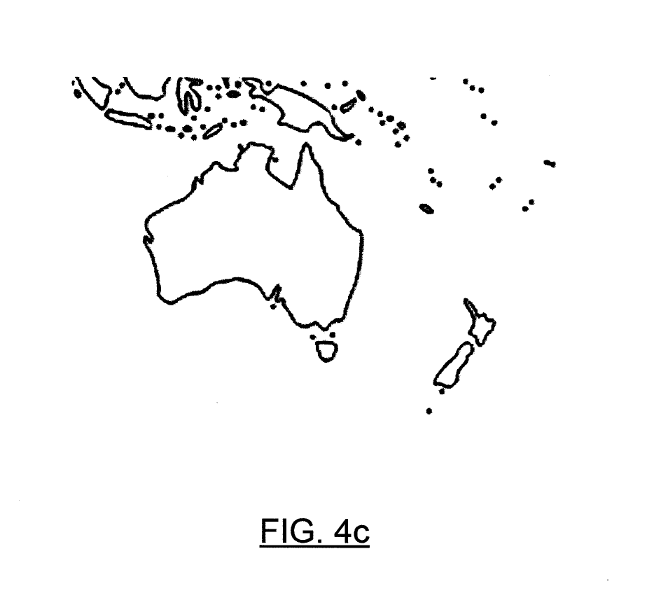

In an example embodiment wherein a first zoom level is a higher zoom level than a second zoom level, the predefined user input may be associated with a panning interaction with the displayed content. In this regard, the content rendering circuitry 118 may be configured to cause display of the content at a pre-rendered lower zoom level to facilitate navigation (e.g., panning) by the user to a different portion of the content, which the user may then select to view at a higher zoom level through a second predefined input. As an example, FIGS. 4a-4c illustrate a series of content renderings for a world map. As illustrated in FIG. 4a, a user may be viewing North America at a first zoom level on a display. The user may wish to view Australia on the map. However, Australia is not visible on the display at the zoom level illustrated in FIG. 4a. Accordingly, the user may provide a first predefined user input to trigger a switch to a lower zoom level wherein more of the map may be visible on the display. In this regard, FIG. 4b illustrates where the map is displayed at a second zoom level in which the entire map is visible on the display area. The user may then more easily navigate to the portion of the map including Australia and may provide a second predefined user input triggering a switch back to the first zoom level. The content rendering circuitry 118 may accordingly be configured to determine the second predefined user input and responsive thereto cause display of the map centered on Australia (e.g., the portion of the map to which the user has navigated through interaction with the zoom level of FIG. 4b) at the first zoom level, as illustrated in FIG. 4c.

While the example of FIGS. 4a-c and other examples are described with respect to the first zoom level being higher than the second zoom level, it will be appreciated that in some embodiments, a first or default zoom level at which content is displayed may be lower than the second zoom level. Such embodiments may be used, for example, to enable a user to first select a portion of content to view in greater detail before selecting to view the selected portion at a higher zoom level.

In embodiments wherein a user may switch between two or more zoom levels and the content is displayed on a touch screen display, the predefined user input may comprise a touch and hold contact gesture. In this regard, when viewing content at a first zoom level, the user may touch the screen and hold contact. Responsive to this gesture, the content rendering circuitry 118 may cause display of the content at a second pre-rendered zoom level. The user may pan or otherwise navigate the content at the second zoom level by dragging across the screen. The user may then release the contact at a position over a portion of the content. Responsive to the release of contact, the content rendering circuitry 118 may again cause display of the content at the first zoom level with the portion of the content at which the release was made being visible (for example, centered) in the display.

In embodiments wherein a user may switch between two or more zoom levels and the content is not displayed on a touch screen display, the predefined user input may comprise a click and hold input to a mouse or other input device. In this regard, when viewing content at a first zoom level, the user may click and hold a button on an input device. Responsive to this gesture, the content rendering circuitry 118 may cause display of the content at a second pre-rendered zoom level. The user may pan or otherwise navigate the content at the second zoom level by manipulating a cursor or other positioning indicator across the screen (e.g., with a mouse, joystick, arrow keys, or the like) while holding the clicked button. The user may then release the clicked button with the cursor at a position over a selected portion of the content. Responsive to the release of clicked button, the content rendering circuitry 118 may again cause display of the content at the first zoom level with the selected portion of the content being visible (for example, centered) in the display.

In some example embodiments, the content rendering circuitry 118 may be configured to pre-render content as a plurality of layers. In this regard, a layer may comprise the content rendered at a particular zoom level. Accordingly, when the content rendering circuitry 118 causes display of content at a particular zoom level, the layer having the content rendered at that zoom level may be visible while the other layer(s) are not visible. The non-visible layers may be layered underneath the visible layer or may be transparent such that only the displayed layer is visible to the user.

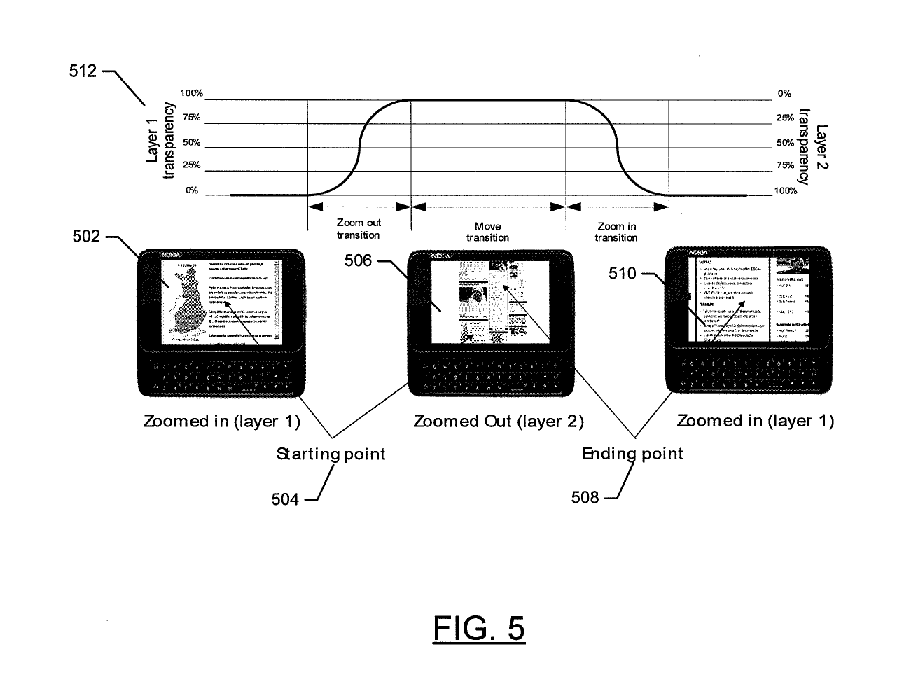

In some embodiments wherein content is pre-rendered as a plurality of layers, the content rendering circuitry 118 may be configured to cause display of a transition effect when switching from a layer having a first zoom level to a layer having a second zoom level. FIG. 5 illustrates an example of content zooming according to one such example embodiment. While FIG. 5 illustrates display of content on a mobile terminal having a touch screen display, it will be appreciated that this illustration is provided by way of example and embodiments wherein the transition effect described with respect to FIG. 5 is applied are not limited to implementation on mobile terminals or on touch screen displays. Further, it will be appreciated that embodiments are not limited to the transition effect illustrated in and described with respect to FIG. 5 and other transition effects between zoom levels and/or layers are contemplated within the scope of the disclosure.

Referring now to FIG. 5, a portion of content 502 in a layer having a first zoom level (layer 1) is displayed on the display. A second layer in which the content is pre-rendered at a second zoom level (layer 2) is not currently visible. In this regard, the transition diagram 512 illustrates that at this point layer 1 is displayed with 0% transparency and layer 2 is either layered underneath layer 2 or is 100% transparent. The user may then provide a predefined input while interacting with the portion of the content 502 to trigger a switch to layer 2. As illustrated in FIG. 5, the user input may have a starting point 504, such as if the predefined input is a touch and hold contact gesture as previously described. Responsive to the input, the content rendering circuitry 118 may cause display of a transition effect between layer 1 and layer 2. This transition effect may, for example, comprise the zoom out transition illustrated in the transition diagram 512. In this regard, the content rendering circuitry 118 may progressively increase a transparency of layer 1 and/or progressively decrease a transparency of layer 2 until layer 2 is visible and layer 1 is not visible on the display. Upon completion of this transition effect, a portion of layer 2 506 may be displayed as illustrated in FIG. 5.

In the example illustrated in FIG. 5, layer 2 comprises a layer having a lower zoom level than layer 1. Accordingly, a user may navigate to a different portion of the content by interacting with layer 2. For example, the user may drag a held contact, cursor, or the like from the starting point 504 to the ending point 508 corresponding to a selected portion of the content. At the ending point 508, the user may provide a second predefined input, such as releasing a held contact, releasing a held input button, or the like. Responsive to predefined input, the content rendering circuitry 118 may cause display of a transition effect between layer 2 and layer 1. This transition effect may, for example, comprise a zoom in transition effect as illustrated in FIG. 5. In this regard, the content rendering circuitry 118 may progressively increase a transparency of layer 2 and/or progressively decrease a transparency of layer 1 until layer 1 is visible and layer 2 is not visible on the display. The portion of layer 1 510 displayed on the display may correspond to a portion of layer 1 centered on the ending point 508.

In some example embodiments wherein transparency effects are used to transition between layers, the content rendering circuitry 118 may be configured to use alpha blending as a technique to handle layer transparency. As an example, consider the example of FIG. 5 wherein there are two layers. The transparency of the layers may be defined with respect to the red, green, blue (RGB) color values for each of a plurality of pixels of the layers by using an alpha value. In this regard, the layer transparencies may be defined as:

displayColor.red=(1−alpha)*layer1.red+alpha*layer2.red

displayColor.green=(1−alpha)*layer1.green+alpha*layer2.green

displayColor.blue=(1−alpha)*layer1.blue+alpha*layer2.blue

Accordingly, if the alpha value is 0.0 then layer 1 may be fully opaque and layer 2 may not be visible. If the alpha value is 1.0, layer 2 may be fully opaque and layer 1 may not be visible. Alpha values in between 0.0 and 1.0 may be used for transitions wherein both layers may be at least somewhat visible by having less than 100% transparency. Accordingly, for example, if the alpha value is 0.5 both layers may have 50% transparency.

In embodiments wherein the content rendering circuitry 118 pre-renders content at three or more zoom levels, a user may provide an input indicating a selected zoom level when triggering a switch to a second zoom level. This input may, for example comprise a multi-tap input to a touch screen display, a multi-click input to a button or other input device, or the like, wherein the user may tap or click a number of times corresponding to the selected zoom level. For example, the pre-rendered zoom levels may be ordered based on the zoom level (for example, in order of increasing or decreasing zoom level). A user may accordingly tap a number of times to iteratively select the desired zoom level. As a further example, in some embodiments wherein the content is displayed on a touch screen display, a user may select a desired zoom level by providing a touch gesture using a corresponding number of fingers, styli, and/or other input means. For example, the zoom levels may be ordered (e.g., 1, 2, 3, . . . ). Accordingly, for example, if a user desires the first zoom level be displayed, the user may provide a touch gesture using a single finger. Correspondingly, if the user desires that the second zoom level be displayed, the user may provide a touch gesture using two fingers. If the user desires that the third zoom level be displayed, the user may provide a touch gesture using three fingers, and so on. As another example, the user may select a desired pre-rendered zoom level from a zoom level selection menu. As such, the content rendering circuitry 118 may be configured to determine the selected zoom level based on the user input and cause the pre-rendered content to be displayed at the selected zoom level. As such, when content is pre-rendered at three or more zoom levels, it will be appreciated that in some example embodiments, a user may be enabled to select a particular desired zoom level and may not be required to iteratively transition between zoom levels.

Accordingly, for example, a second zoom level at which content is displayed may actually comprise, for example, a third or fourth zoom level when the plurality of zoom levels are ordered based on magnitude, for example, from highest to lowest zoom level. As an example, content may be pre-rendered at a 50% zoom level, 100% zoom level, 200% zoom level, and a 400% zoom level. The content may be first displayed at the 50% zoom level. The user may select the 400% zoom level as a second zoom level at which the content is to be displayed. Accordingly, while the 400% zoom level may comprise the fourth zoom level when sequentially ordered based on the magnitude of the zoom level, it may be the second zoom level displayed, as a user may skip over a zoom level of an intermediate magnitude without each zoom level being sequentially displayed.

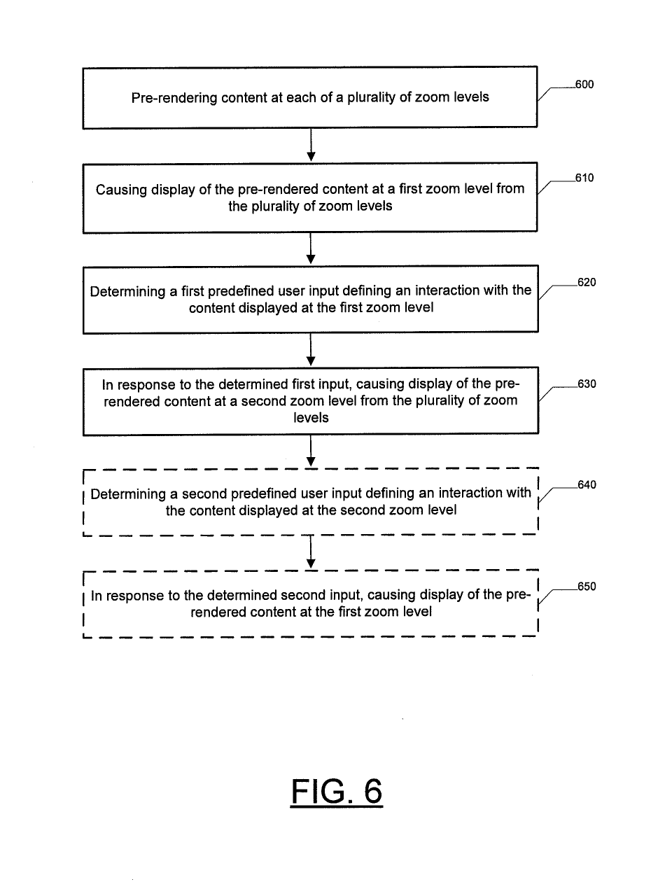

FIG. 6 illustrates a flowchart according to an example method for facilitating content navigation according to an example embodiment. The operations illustrated in and described with respect to FIG. 6 may, for example, be performed by, with the assistance of, and/or under the control of one or more of the processor 110, memory 112, communication interface 114, user interface 116, or content rendering circuitry 118. Operation 600 may comprise pre-rendering content at each of a plurality of zoom levels. The processor 110, memory 112, and/or content rendering circuitry 118 may, for example, provide means for performing operation 600. Operation 610 may comprise causing display of the pre-rendered content at a first zoom level from the plurality of zoom levels. The processor 110, memory 112, content rendering circuitry 118, and/or user interface 116 may, for example, provide means for performing operation 610. Operation 620 may comprise determining a first predefined user input defining an interaction with the content displayed at the first zoom level. The processor 110, memory 112, content rendering circuitry 118, and/or user interface 116 may, for example, provide means for performing operation 620. Operation 630 may comprise, in response to the determined first input, causing display of the pre-rendered content at a second zoom level from the plurality of zoom levels. The processor 110, memory 112, content rendering circuitry 118, and/or user interface 116 may, for example, provide means for performing operation 630.

The method may optionally further include operations 640 and 650. Operation 640 may comprise determining a second predefined user input defining an interaction with the content displayed at the second zoom level. The processor 110, memory 112, content rendering circuitry 118, and/or user interface 116 may, for example, provide means for performing operation 640. Operation 650 may comprise, in response to the determined second input, causing display of the pre-rendered content at the first zoom level. The processor 110, memory 112, content rendering circuitry 118, and/or user interface 116 may, for example, provide means for performing operation 650.

FIG. 6 is a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., a terminal apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements. In another embodiment, all or a portion of the elements may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
pre-rendering content at each of a plurality of zoom levels, the plurality of zoom levels comprising a first zoom level and a second zoom level;
causing display of the pre-rendered content at the first zoom level;
determining a first predefined user input defining an interaction with the content displayed at the first zoom level; and
in response to the determined first input, causing display of the pre-rendered content at the second zoom level.

2. The method according to claim 1, wherein the second zoom level is lower than the first zoom level and only a portion of the content is visible on a display when the pre-rendered content is displayed at the first zoom level, and wherein:
determining the first predefined user input comprises determining a user input defining an interaction associated with panning the displayed content; and
causing display of the pre-rendered content at the second zoom level comprises causing display of the pre-rendered content at the lower zoom level, thereby facilitating navigation to a different portion of the content.

3. The method according to claim 1, wherein:
pre-rendering the content at each of the plurality of zoom levels comprises pre-rendering the content as a plurality of layers, the content being pre-rendered at the first zoom level in a first layer and at the second zoom level in a second layer;
causing display of the pre-rendered content at the first zoom level comprises causing display of the first layer, whereby the first layer is visible and the second layer is not visible; and
causing display of the pre-rendered content at the second zoom level comprises one or more of progressively increasing a transparency of the first layer or progressively decreasing a transparency of the second layer until the second layer is visible and the first layer is not visible, thereby providing a transition between the first zoom level and the second zoom level.

4. The method according to claim 1, further comprising:
determining a second predefined user input defining an interaction with the content displayed at the second zoom level; and
in response to the determined second input, causing display of the pre-rendered content at the first zoom level.

5. The method according to claim 4, wherein:
causing display of the pre-rendered content at the first and second zoom levels comprises causing display of the pre-rendered content on a touch screen display;
the first predefined user input comprises a touch and hold contact gesture input to the touch screen display; and
the second predefined user input comprises a release of the touch and hold contact gesture from the touch screen display.

6. The method according to claim 1, wherein the plurality of zoom levels comprises three or more zoom levels, and the determined first input defines a selection of the second zoom level from the plurality of zoom levels, the method further comprising:
determining, based at least in part on the first input, the selected second zoom level.

7. The method according to claim 1, wherein the content comprises a web page and causing display of the pre-rendered content at the first and second zoom levels comprises causing display of the pre-rendered web page at the first and second zoom levels in a web browser.

8. The method according to claim 1, wherein causing display of the pre-rendered content at the first and second zoom levels comprises causing display of the pre-rendered content on a display of a mobile terminal.

9. The method according to claim 1, wherein pre-rendering content comprises pre-rendering the content by a processor.

10. An apparatus comprising at least one processor and at least one memory storing computer program code, wherein the at least one memory and stored computer program code are configured, with the at least one processor, to cause the apparatus to at least:
pre-render content at each of a plurality of zoom levels, the plurality of zoom levels comprising a first zoom level and a second zoom level;
cause display of the pre-rendered content at the first zoom level;
determine a first predefined user input defining an interaction with the content displayed at the first zoom level; and
in response to the determined first input, cause display of the pre-rendered content at the second zoom level.

11. The apparatus according to claim 10, wherein the second zoom level is lower than the first zoom level and only a portion of the content is visible on a display when the pre-rendered content is displayed at the first zoom level, and wherein the at least one memory and stored computer program code are configured, with the at least one processor, to cause the apparatus to:
determine the first predefined user input by determining a user input defining an interaction associated with panning the displayed content; and
cause display of the pre-rendered content at the second zoom level by causing display of the pre-rendered content at the lower zoom level, thereby facilitating navigation to a different portion of the content.

12. The apparatus according to claim 10, wherein the at least one memory and stored computer program code are configured, with the at least one processor, to cause the apparatus to:
pre-render the content at each of the plurality of zoom levels by pre-rendering the content as a plurality of layers, the content being pre-rendered at the first zoom level in a first layer and at the second zoom level in a second layer;
cause display of the pre-rendered content at the first zoom level by causing display of the first layer, whereby the first layer is visible and the second layer is not visible; and
cause display of the pre-rendered content at the second zoom level by one or more of progressively increasing a transparency of the first layer or progressively decreasing a transparency of the second layer until the second layer is visible and the first layer is not visible, thereby providing a transition between the first zoom level and the second zoom level.

13. The apparatus according to claim 10, wherein the at least one memory and stored computer program code are configured, with the at least one processor, to further cause the apparatus to:
determine a second predefined user input defining an interaction with the content displayed at the second zoom level; and
in response to the determined second input, cause display of the pre-rendered content at the first zoom level.

14. The apparatus according to claim 13, wherein:
the at least one memory and stored computer program code are configured, with the at least one processor, to cause the apparatus to cause display of the pre-rendered content at the first and second zoom levels by causing display of the pre-rendered content on a touch screen display;
the first predefined user input comprises a touch and hold contact gesture input to the touch screen display; and
the second predefined user input comprises a release of the touch and hold contact gesture from the touch screen display.

15. The apparatus according to claim 10, wherein the plurality of zoom levels comprises three or more zoom levels, and the determined first input defines a selection of the second zoom level from the plurality of zoom levels, and wherein the at least one memory and stored computer program code are configured, with the at least one processor, to further cause the apparatus to:
determine, based at least in part on the first input, the selected second zoom level.

16. The apparatus according to claim 10, wherein the content comprises a web page, and wherein the at least one memory and stored computer program code are configured, with the at least one processor, to cause the apparatus to cause display of the pre-rendered content at the first and second zoom levels by causing display of the pre-rendered web page at the first and second zoom levels in a web browser.

17. The apparatus according to claim 10, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one non-transitory computer-readable storage medium having computer-readable program instructions stored therein, the computer-readable program instructions comprising:
program instructions configured to pre-render content at each of a plurality of zoom levels, the plurality of zoom levels comprising a first zoom level and a second zoom level;
program instructions configured to cause display of the pre-rendered content at the first zoom level;
program instructions configured to determine a first predefined user input defining an interaction with the content displayed at the first zoom level; and
program instructions configured, in response to the determined first input, to cause display of the pre-rendered content at the second zoom level.

19. The computer program product according to claim 18, wherein the second zoom level is lower than the first zoom level and only a portion of the content is visible on a display when the pre-rendered content is displayed at the first zoom level, and wherein:
the program instructions configured to determine the first predefined user input comprise program instructions configured to determine a user input defining an interaction associated with panning the displayed content; and
the program instructions configured to cause display of the pre-rendered content at the second zoom level comprise program instructions configured to cause display of the pre-rendered content at the lower zoom level, thereby facilitating navigation to a different portion of the content.

20. The computer program product according to claim 18, wherein:
the program instructions configured to pre-render the content at each of the plurality of zoom levels comprise program instructions configured to pre-render the content as a plurality of layers, the content being pre-rendered at the first zoom level in a first layer and at the second zoom level in a second layer;
the program instructions configured to cause display of the pre-rendered content at the first zoom level comprise program instructions configured to cause display of the first layer, whereby the first layer is visible and the second layer is not visible; and
the program instructions configured to cause display of the pre-rendered content at the second zoom level comprise program instructions configured to one or more of progressively increase a transparency of the first layer or progressively decrease a transparency of the second layer until the second layer is visible and the first layer is not visible, thereby providing a transition between the first zoom level and the second zoom level.
